(19) United States
(12) Patent Application Publication
(10) Pub. No.: US 2008/0050018 A1
(43) Pub. Date: Feb. 28, 2008

(54) Method for generating dynamic representations for visual tests to distinguish between humans and computers

(75) Inventor: Jason Koziol, Naperville, IL (US)

Correspondence Address: JASON KOZIOL, 1512 SWALLOW ST., NAPERVILLE, IL, 60565, US

(73) Assignee: Jason Koziol, Naperville, IL (US)

(21) Appl. No.: 11/467,218

(22) Filed: Aug. 25, 2006

(51) Int. Cl. G06K 9/00

(52) U.S. Cl. 382/187; 382/100

(57) ABSTRACT

A method is disclosed for using software, to generate a representation of a visual test challenge, the answer to which may be used to distinguish between responses returned by a human, and responses returned by a computer-automated system, that substantially and reliably improves upon ordinary methods of such distinction.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF INVENTION

Client-server software applications usually offer use of server-side resources to multiple clients. In cases where the server and client communicate through a fast and compact protocol, such as in the case of a web-based internet application, the client base can be large, dynamic, and effectively anonymous. In these cases, it can become a more important goal of the server to distinguish between human clients who are accessing the content and resources of the server for legitimate reasons, and computer-automated systems designed to misuse or abuse the server's resources, or otherwise misrepresent their requests for access to the server's resources.

As the web has evolved, and server-side resources have become more valuable, offers of web services by various companies in pursuit of various objectives have grown, and understanding of how to exploit them has grown at the same time. Tests, of the variety of static images of numbers and letters, with various distortions and deliberately increased noise-to-signal ratio, have become commonly used to help distinguish humans from computers, to protect the server from misrepresented requests to access its resources. The tests are described by the term CAPTCHA, an acronym for Completely Automatic Public Turing test to tell Computers and Humans Apart, which originated at Carnegie-Mellon.

Unfortunately, Optical Character Recognition (OCR) technology advances have been applied to defeat almost every implementation of static image CAPTCHA. Furthermore, advances in the technology of the creation of static images that are more easily recognizable by humans than computers do not sufficiently outpace advances in OCR and other defeating technologies.

The following websites contain information relevant to the invention and prior art:

http://www.captcha.net/

http://www.w3.org/TR/SVG/

http://en.wikipedia.org/wiki/Optical_character_recognition

The following USPTO class definitions are relevant to the classification of the invention, the claims herein, or the example implementations: 706/60, 706/46, 726/28, 726/4, 715/535, 715/848, 345/653, 345/469, 709/203, 709, 225, 719/311, 719/319, 434/36, 434/346, 700/89, 702/193, 706/11, 715/515, 715/782, 715/703, 715/502, 715/542, 715/863, 345/420, 345/427, 345/592, 345/630, 345/632, 345/644, 345/647, 345/648, 345/471, 434/102.

### BRIEF SUMMARY OF THE INVENTION

The invention substantially improves upon the practice and process of static image generation for visual tests to distinguish between computers and humans by providing for a system of representation and interaction that allows for rapid, dynamic transformations of symbolic representations. In other words, instead of showing a static image of a deformed numeral ‘1’, and relying on recognition technologies to fail to recognize it, while humans still easily recognize it, said invention will allow even an undistorted three-dimensional representation of a numeral ‘1’ to be sent to a client as a challenge that will present a substantial problem for automated recognition technology to recognize, but will be easy for a human to quickly find the correct rendering configuration for, and thus easily recognize.

### BRIEF DESCRIPTION OF THE SEVERAL VIEWS OF THE DRAWING

An earnest effort has been made to accurately convey relevant aspects of the method through drawings. However, since the method depends upon the superiority of dynamic, interactive representations over static images for the conveyance of certain types of information, this aspect might not be sufficiently illustrated.

Listing of all figures:

FIG. 1 shows a block font representation of numeral ‘1’.

FIG. 2 shows a block font representation of numeral ‘1’ with relative, two-dimensional rendering vectors.

FIG. 3 shows a reference for three-dimensional rotation angles. A change in the alpha angle refers to a rotation about the x-axis, and a change in the beta angle refers to a rotation about the y-axis.

FIGS. 4a through 4e show a series of images illustrating the rotation of a two-dimensional representation of a symbol. The change of beta is 90 degrees, and the change of alpha is 45 degrees.

FIGS. 5a through 5e show a series of images illustrating the rotation of a three-dimensional representation of a symbol, where the z coordinates of each point have been distorted. The change of beta is 90 degrees, and the change of alpha is 45 degrees.

FIG. 6 shows detail of the side view of the rotated symbol, where one z coordinate of each rendering line has been included.

FIG. 7 shows an example of extending the method through the addition of data by adding orthogonal projections for a third rendered dimension of a symbol.

FIGS. 8a through 8d show an example of extending the method through the addition of data, by adding rendering vectors for a second symbol, rotated orthogonally to the challenge symbol, and colored differently. The series shows both symbols rotated simultaneously through 3 changes in beta by 45 degrees. A false symbol, the numeral ‘2’, appears when the correct symbol is still unrecognizable, but the correct symbol, the numeral ‘1’, is recognizable after further rotation.

FIG. 9 shows a distorted, but still recognizable, challenge symbol.

FIG. 10 shows a noisy, but still recognizable, challenge symbol.

FIGS. 11a through 11h show an example of a dynamic system of representations based on rotating polarized plates instead of rotating a three-dimensional model. FIG. 11a shows the initial representation sent to the client. FIGS. 11b through 11g show smooth changes in the representation as the user interacts with the system. FIG. 11h shows the representation at the correct angle.

### REQUIREMENTS

The following are required in order to implement the method described herein as a system of automatic generation of representations of visual tests. These items are common and publicly available, and an example is provided for each.
(1) Client-server software application. Example: a web-based internet application, consisting of a web server that offers access to services or other resource to authorized users, and a remote client.
(2) Ability to serve data to client and interpret data as part of an application. Example: a web browser and application data in hypertext format.
(3) Rendering data for symbols that a human user in the client base of the application could be expected to recognize with high probability, expressed as two-dimensional vectors. Example: all alphanumeric characters of a common block font (straight lines only), wherein each character is reduced to a set of pairs of two-dimensional vectors for each point between which a line would be drawn to render the character recognizable to a human.
(4) Ability to execute server-side instructions. Example: common gateway interface scripting.
(5) Ability to render two-dimensional vector data. Example: scalable vector graphics formatted data.
(6) Ability to deliver and compel execution of client-side processing instructions, including floating-point arithmetic, and array storage capability. Example: ecmascript.

### DETAILED DESCRIPTION OF THE INVENTION

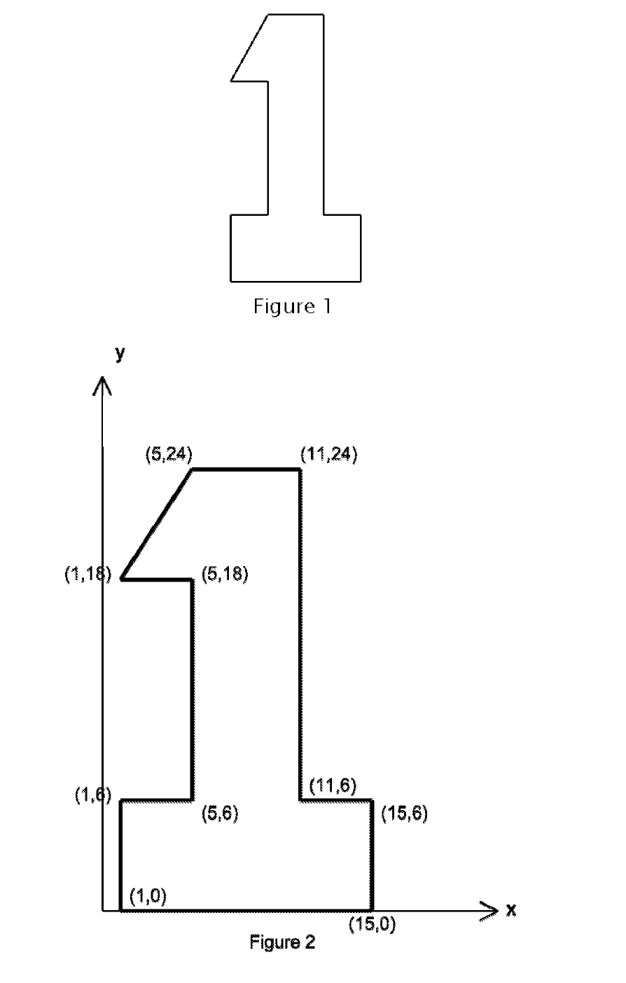

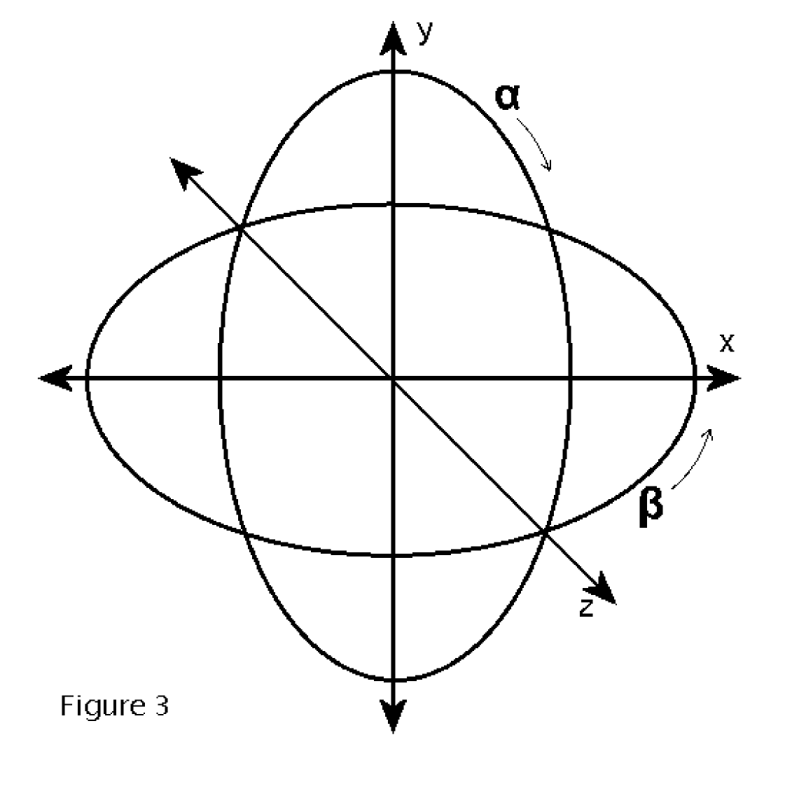

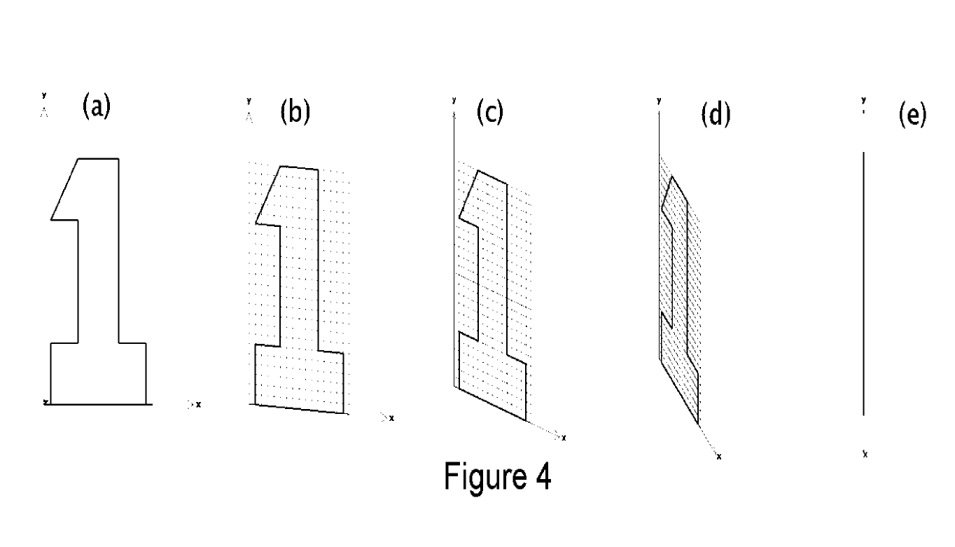

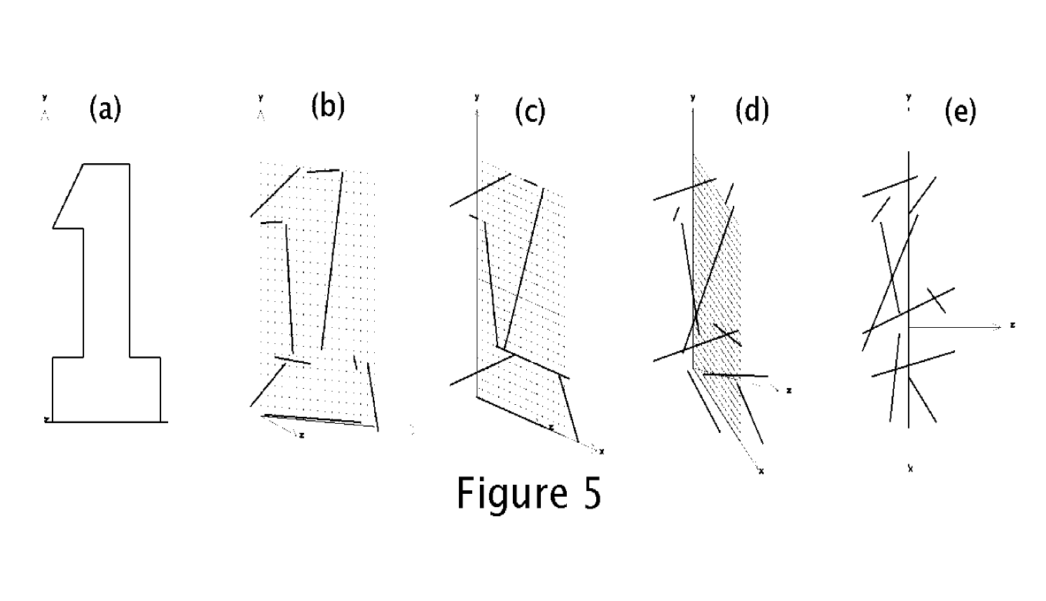

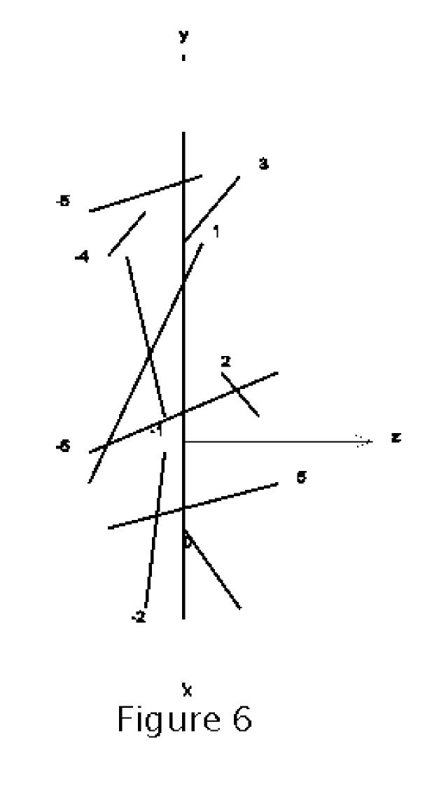

The following steps should be taken by a system of software to generate representations of visual tests, and collect and evaluate responses for the purpose described herein.
(1) On the server side of the application, select the vector data for a series of appropriate recognition challenge symbols, such as a set of alphanumeric characters. (See FIGS. 1 and 2, and Table 1.)
(2) Store the series of symbols in a format that can be compared to a client response, such as an ASCII character string, and in such a way that it can be retrieved and known only by the server when the client returns the response.
(3) Along the normal viewing angle with respect to the rendering of the symbols, add a distorted depth coordinate such that an orthogonal projection along the normal viewing angle reproduces the original, recognizable symbol, but that projections of these same, now three-dimensional vectors along any other angles produce unrecognizable representations. (The reverse of the norm and its rotations may still reproduce the symbol flipped or mirrored.) (See Table 2.)
(4) Transform the resulting data into an orthogonal projection of the vectors along a different angle from the normal viewing angle of the symbols, such that the normal viewing angle is neither contained in nor is an obvious correction from the given orthogonal projection angle, leaving it effectively lost. Note: This step has been skipped in the data and illustrations. (See FIGS. 4, 5, and 6 for an illustration of the degenerate case.)
(5) Deliver or otherwise establish client-side executable instructions and the data resulting from steps (1-4) such that simple user interface operations, as a mouse drag or keyboard press, allow the user to smoothly and variably transform the vectors through all possible viewing angles
(6) Upon receipt of the response to the challenge from the client within a suitable timeframe, compare it to the stored answer from step (2). If the response to the challenge matches, there is a significantly higher probability that the responding client is a human than if the rendering data are sent and rendered before said method is applied.

TABLE 1

| Line | X1 | Y1 | X2 | Y2 |
|---|---|---|---|---|
| Line 1 | 1 | 0 | 1 | 6 |
| Line 2 | 1 | 6 | 5 | 6 |
| Line 3 | 5 | 6 | 5 | 18 |
| Line 4 | 5 | 18 | 1 | 18 |
| Line 5 | 1 | 18 | 5 | 24 |
| Line 6 | 5 | 24 | 11 | 24 |
| Line 7 | 11 | 24 | 11 | 6 |
| Line 8 | 11 | 6 | 15 | 6 |
| Line 9 | 15 | 6 | 15 | 0 |
| Line 10 | 15 | 0 | 1 | 0 |

TABLE 2

| Line | X1 | Y1 | Z1 | X2 | Y2 | Z2 |
|---|---|---|---|---|---|---|
| Line 1 | 1 | 0 | 5 | 1 | 6 | −5 |
| Line 2 | 1 | 6 | −2 | 5 | 6 | −4 |
| Line 3 | 5 | 6 | 1 | 5 | 18 | 3 |
| Line 4 | 5 | 18 | 4 | 1 | 18 | 2 |
| Line 5 | 1 | 18 | 5 | 5 | 24 | −1 |
| Line 6 | 5 | 24 | −3 | 11 | 24 | 0 |
| Line 7 | 11 | 24 | −1 | 11 | 6 | 5 |
| Line 8 | 11 | 6 | −5 | 15 | 6 | 4 |
| Line 9 | 15 | 6 | 0 | 15 | 0 | −3 |
| Line 10 | 15 | 0 | 2 | 1 | 0 | 1 |

### Mundane Extensions

The method described herein may be extended in several mundane ways, either manually or programmatically, that can provide for more reliability in further challenging computer-automated clients to return a correct response: through configuration of data, adjustment of operational parameters, the addition of data, or further distortion.

Optionally, the initial symbol vector data may be extended or reconfigured, including adding curves to the block renderings, rendering different fonts, rendering additional symbols, or rendering non-alphanumeric symbols altogether. There are many ways to extend the method, through configuration of data, which have the similar effect of increasing the reliability of the method.

Optionally, the operational parameters for the software implementing the method may be adjusted. For example, the software implementation may render multiple symbols at once, and the projections of the elements of each complete rendering may be mixed in such a way, that whether or not an element is a part of one completely rendered symbol or another is only clear when viewing the projection from the normal angle. As another example of this type of extension, the interaction system may be altered so that, when multiple symbols are rendered, no two symbols share the same correct rendering angle. There are many ways to extend the method, through the adjustment of operational parameters, which have the similar effect of increasing the reliability of the method.

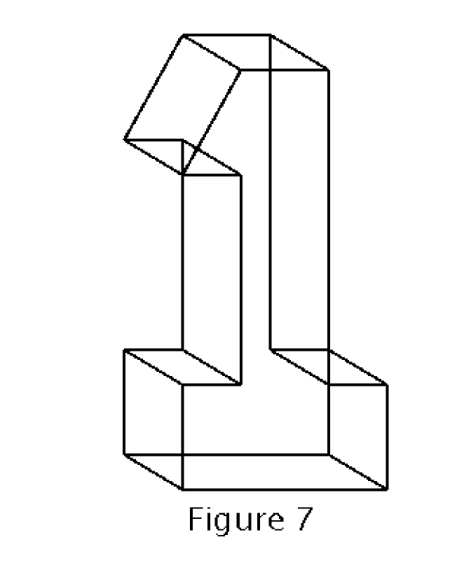

Optionally, meaningful data may be added to the initial symbol vector data. An example is illustrated in FIG. 7, wherein vector data for a third rendered dimension of the projection of a symbol has been added. As another example of this type of extension, illustrated in FIG. 8, an additional symbol's vector data has been added to the challenge symbol's, but the second symbol's vectors have been transformed so that its projection appears normal at a different angle than the challenge symbol. The second symbol's projection has been rendered with differently colored lines, as an example of a distinction that can be used by a human client to identify and return the correct symbol as a response to a challenge. There are many ways to extend the method, through the addition of data, which have the similar effect of increasing the reliability of the method.

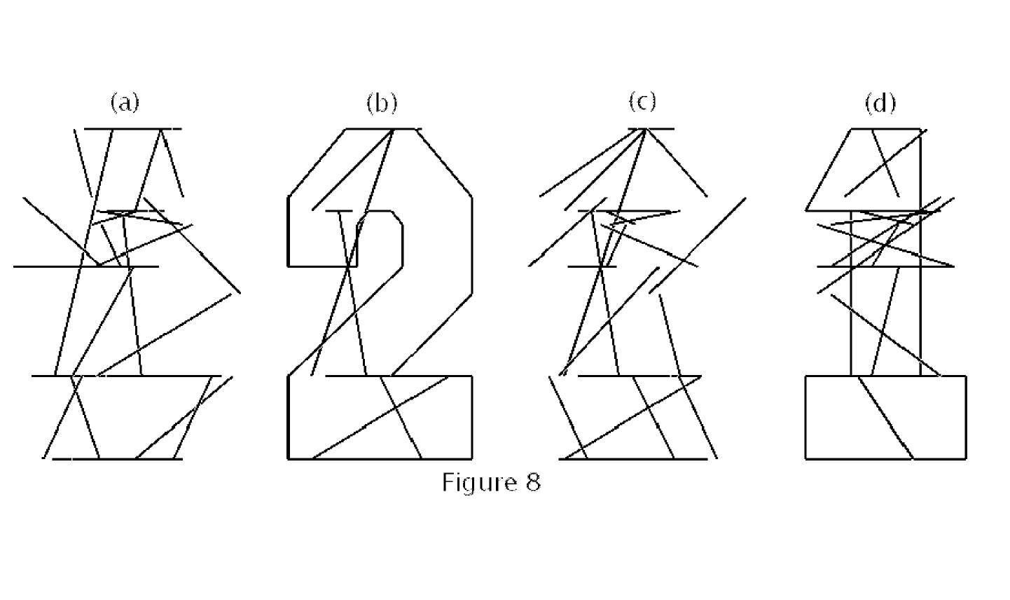

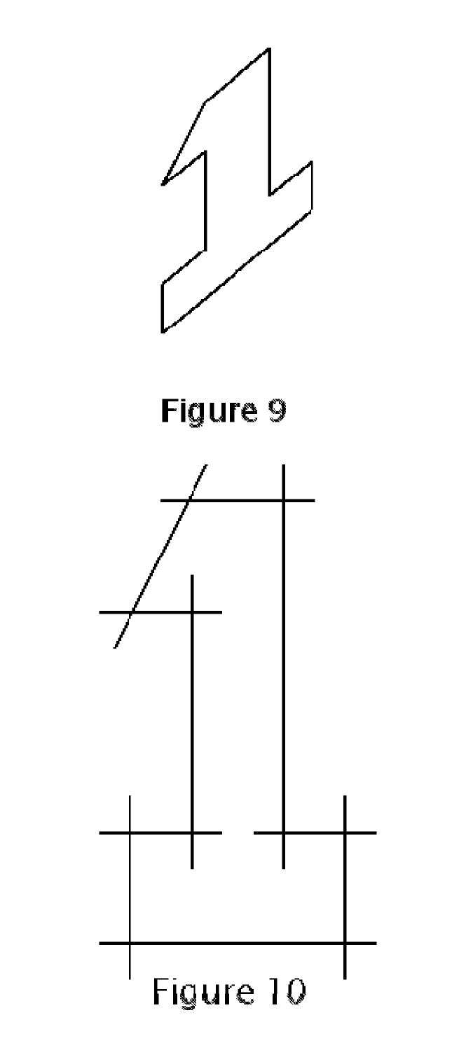

Optionally, the initial vector data of the challenge symbols may be transformed so that the symbols appear distorted at the normal viewing angle. An example of an initially distorted, but still recognizable, challenge symbol is shown in FIG. 9. Also, visually represented noise—rendered elements that are not part of the rendered challenge symbol—may be added. An example of a noisy, but still recognizable, challenge symbol is shown in FIG. 10. There are many ways to extend the method, through the distortion of symbols or the addition of noise, which have the similar effect of increasing the reliability of the method.

### Non-Mundane Extensions

The method described herein may also be extended in several non-mundane ways, through enhancement or improvement of the algorithms necessary in a software implementation of the method, that can provide for more reliability in further challenging computer-automated clients to return a correct response: through alterations in the software's process for distortion of data, its process for transformation of data, or its process for handling of client interaction with the dynamic system of representation.

Optionally, the implementing software's process for distorting the initial data may be altered. For example, the software's process for distorting the z-coordinates of the symbol vector data can be enhanced so that a given element of the three-dimensional model has the same probability of crossing the center of the model as do the elements of the two-dimensional symbols. As a further example, the z-coordinates may be specifically chosen that cause the projection of partially recognizable symbols at angles other than the normal viewing angle. There are many ways to extend the method, through alteration of the software's process for distortion of data, which have the similar effect of increasing the reliability of the method.

Optionally, the implementing software's process for transforming the data may be altered. For example, the initial rotation transformation that occurs on the server side to hide the normal viewing angle, can be enhanced so that the given angle is derived dynamically, based on what angle would be least likely to yield information about the radial distance and direction of the normal viewing angle for the challenge symbol. As another example, the rotation transformations that occur on the client side to render the three-dimensional model from different angles, can be enhanced so that individual elements of the model are rotated about their own axes, while a camera is rotated around the model. There are many ways to extend the method, through alteration of the software's process for transformation of data, which have the similar effect of increasing the reliability of the method.

Optionally, the implementing software's process for handling client interaction with the dynamic system of representation data may be altered. For example, mouse movement events may be tracked non-linearly, so that rotation transformations occur at larger angles when the mouse cursor is moving quickly, and at smaller angles when it is moving slowly. There are many ways to extend the method, through alteration of the software's process for handling client interaction with the dynamic system of representation data, which have the similar effect of increasing the reliability of the method.

Optionally, both mundane and non-mundane extensions may be combined to produce a significantly different dynamic system of representations of visual tests. To optionally extend the method in this way:
(1) Select a system of interacting elements that a human can readily map to common experience, and that can be clearly represented visually in a two-dimensional, dynamic rendering.
(2) Create initial data for symbols that can be represented by the visual representations of the interacting elements well enough to be recognized by a human.
(3) Create client software for continuously varying parameters of the dynamic system.
(4) Create a process for distorting the initial data so that the correct rendering configuration is lost but can be found by interaction with the system.
(5) Implement in software according to the method described above, skipping, modifying, or adding steps when necessary.
(6) Optionally apply additional extensions to further increase reliability.

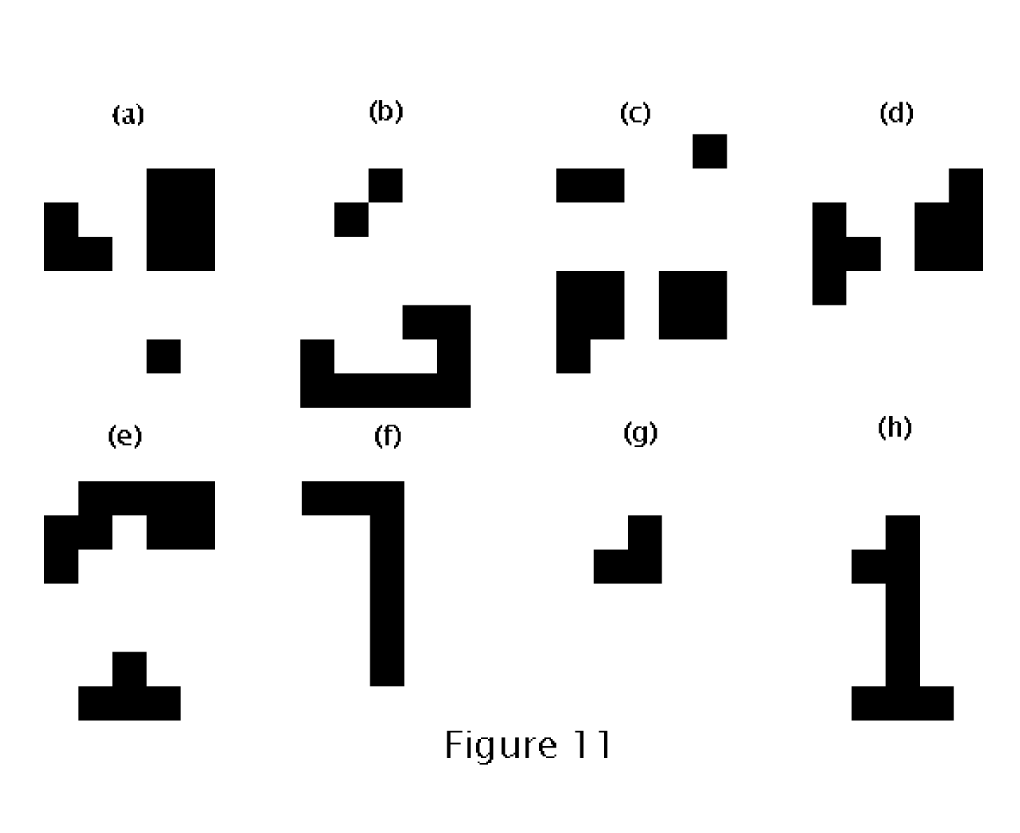

As an example, the initial data, transformations, and interactions can all be simultaneously altered so that a collection of overlapping, polarized plates of transparent material are represented, and the client interacts with them to change the z-axis, or gamma, angle of orientation of two subsets of them. The recognizable symbol appears when the two sets are both oriented at the correct polarization angle, and unrecognizable visual representations appear at all other angles. An illustration of such a system is shown in FIG. 11.

### Description of Prototypical Embodiment

The prototypical implementation consists of a client-server web application. The server uses the following software:

Apache HTTP server 2.0.55

ActivePerl 5.8.7 Build 815

Altova XML processing engine

The client uses the following software:

Firefox 1.5.0.6

The application utilizes the following languages/technologies:

XSL 2.0

SVG 1.1

Perl 6

XHTML

Javascript

Initial data for the challenge symbols is created using a text editor, directly editing XML text formatted according to the SVG 1.1 specification, using the <line> element to plot points in a 24×16 grid, and connecting them to approximate block font representations of the Arabic numerals 0-9. (See Table 3 below, which contains vector data for the Arabic numeral ‘1’.)

TABLE 3

```
<g stroke=“black” stroke-width=“2” stroke-opacity=“0”>
    <line x1=“1 ” y1=“24” x2=“1 ” y2=“18”/>
    <line x1=“1 ” y1=“18” x2=“5 ” y2=“18”/>
    <line x1=“5 ” y1=“18” x2=“5 ” y2=“6 ”/>
    <line x1=“5 ” y1=“6 ” x2=“1 ” y2=“6 ”/>
    <line x1=“1 ” y1=“6 ” x2=“5 ” y2=“0 ”/>
    <line x1=“5 ” y1=“0 ” x2=“11” y2=“0 ”/>
    <line x1=“11” y1=“0 ” x2=“11” y2=“18”/>
    <line x1=“11” y1=“18” x2=“15” y2=“18”/>
    <line x1=“15” y1=“18” x2=“15” y2=“24”/>
    <line x1=“15” y1=“24” x2=“1 ” y2=“24”/>
</g>
```

The Apache http server is configured to allow server-side script handling for requests ending with ‘.pl’. The Perl script generate_dyn_rep.pl (see Table 4 below) handles a request that contains the parameters: ‘number’, ‘answer’, and ‘guess’, which contain integers.

TABLE 4
#! perl.exe -w
use strict;
use CGI;
use CGI::Carp qw/fatalsToBrowser/;
# Create a new cgi object
my $cgi = CGI->new( );
# Retrieve parameters from http request
my ($answer) = ($cgi->param(“answer”));
my ($number) = ($cgi->param(“number”));
my ($guess) = ($cgi->pararm(“guess”));
# Set http response type
print $cgi->header(-type=>‘text/xml’,

-charset=>‘utf-8’);

```
# Set path variables
my $root =$ENV{“DOCUMENT_ROOT”};
my $path = “dynrep”;
# Set xslt transformation process arguments (print output directly to http
response)
my @args = (“altovaxml.exe”,
  “/xslt2”, “$root/$path/generate_dyn_rep.xsl”,
  “/in”, “$root/$path/dummy.xml”, #required
  “/param”, “answer=\‘$answer\’”,
  “/param”, “number=\‘$number\’”,
  “/param”, “guess=\‘$guess\’”);
# Spawn xslt transformation process
system(@args) == 0
    or die “system args failed: $?”;
```

The Perl script passes the file and parameters to the AltovaXML processing engine, which transforms a dummy XML file according to the XSLT script generate_dyn_rep.xsl. If the ‘number’ parameter is non-null, the XSLT script parses each digit out of the number and returns the inline SVG representation of that digit within the XHTML response. (See Table 5 below.) The number is also stored in the hidden field ‘answer’ for convenience.

```
TABLE 5
<xsl:stylesheet version=“2.0”
  xmlns:xsl=“http://www.w3.org/1999/XSL/Transform”
  xmlns:fn=“http://www.w3.org/2005/02/xpath-functions”
  xmlns:svg=“http://www.w3.org/2000/svg”>
<xsl:output indent=“yes” encoding=“UTF-8”/>
<xsl:variable name=“control_script” select=“‘transform.js’”/>
<xsl:param name=“answer” />
<xsl:param name=“number” select=“‘0’”/>
<xsl:param name=“guess” />
<xsl:template match=“/”>
<html xmlns=“http://www.w3.org/1999/xhtml”
    xmlns:svg=“http://www.w3.org/2000/svg”
    xmlns:xlink=“http://www.w3.org/1999/xlink”>
  <head>
      <meta content=“text/xml; charset=UTF-8”
        http-equiv=“Content-Type”></meta>
      <title>Generate Dynamic Representation</title>
      <!-- Embed initialization and client-interaction script -->
    <script type=“text/javacript”>
        <xsl:attribute name=“src”>
          <xsl:value-of select=“$control_script”/>
        </xsl:attribute>
      </script>
  </head>
  <body>
    <!-- Select the single number parameter -->
    <xsl:for-each select=“$number”>
      <!-- Include a user validation form -->
      <form method=“post” action=“/generate_dyn_rep.pl”>
        <!-- Store the answer in a hidden field -->
        <input type=“hidden” name=“answer”>
          <xsl:attribute name=“value”>
            <xsl:value-of select=“$number”/>
          </xsl:attribute>
        </input>
        <!-- Include user input fields -->
        <xsl:text>Number:</xsl:text>
        <input type=“text” name=“number” maxlength=“10”></input>
        <xsl:text>Guess:</xsl:text>
        <input type=“text” name=“guess” maxlength=“10”></input>
        <input type=“submit” title=“submit”></input>
        <!-- Check the user's user's response to the previous
        challenge -->
        <xsl:if test=“$guess!=‘’”>
          <span style=“margin-left:10px”>
            <xsl:if test=“$guess=$answer”>
              <xsl:text>Correct</xsl:text>
            </xsl:if>
            <xsl:if test=“$guess!=$answer”>
              <xsl:text>Incorrect</xsl:text>
            </xsl:if>
          </span>
        </xsl:if>
      </form>
      <!-- Include the dynamic representation as a single inline SVG -->
      <svg:svg id=“svg1”
        xmlns:xlink=“http://www.w3.org/1999/xlink”
        xmlns:xhtml=“http://www.w3.org/1999/xhtml”
        width=“100%”
        height=“100%”
        onmousedown=“beginDrag(evt)”
        onmousemove=“continueDrag(evt)”
        onmouseup=“endDrag(evt)”
        xmlns=“http://www.w3.org/2000/svg”>
        <!-- Embed the same script in the SVG -->
        <script type=“text/javascript”>
          <xsl:attribute name=“xlink:href”>
            <xsl:value-of select=“$control_script”/>
          </xsl:attribute>
        </script>
        <!-- Send number to parsing template -->
        <xsl:call-template name=“digit”>
          <xsl:with-param name=“string” select=“.”/>
          <xsl:with-param name=“length”
          select=“string-length($number)”/>
          <xsl:with-param name=“index” select=“1”/>
        </xsl:call-template>
      </svg:svg>
    </xsl:for-each>
  </body>
</html>
</xsl:template>
<!-- Parse digits recursively -->
<xsl:template name=“digit”>
  <xsl:param name=“string”/>
  <xsl:param name=“length”/>
  <xsl:param name=“index”/>
  <!-- Check for end of number string -->
  <xsl:if test=“$index &lt;= $length”>
    <!-- Get a digit -->
    <xsl:variable name=“n” select=“substring($string,$index,1)”/>
    <!-- Set the offset so digits don't display overlapped -->
    <xsl:variable name=“offset”>
        <xsl:value-of select=“($index) * 20”/>
    </xsl:variable>
    <!-- Match and copy the data for this digit -->
    <xsl:if test=“$n=‘0’”>
      <xsl:call-template name=“svg_zero”>
        <xsl:with-param name=“offset” select=“$offset”/>
      </xsl:call-template>
    </xsl:if>
    <xsl:if test=“$n=‘1’”>
      <xsl:call-template name=“svg_one”>
        <xsl:with-param name=“offset” select=“$offset”/>
      </xsl:call-template>
    </xsl:if>
    <!-- (Remaining digit comparisons cut for brevity) -->
    <!-- Recursively call this template until the string is parsed -->
    <xsl:call-template name=“digit”>
      <xsl:with-param name=“string” select=“$string”/>
      <xsl:with-param name=“length” select=“$length”/>
      <xsl:with-param name=“index” select=“$index+1”/>
    </xsl:call-template>
  </xsl:if>
</xsl:template>
<xsl:template name=“svg_zero”>
  <xsl:param name=“offset”/>
  <svg:g stroke=“black” stroke-width=“1” stroke-opacity=“0”>
    <xsl:attribute name=“transform”>translate(<xsl:value-of
select=“$offset”/>,10)</xsl:attribute>
    <!-- Import svg data here for numeral ‘0’ -->
  </svg:g>
</xsl:template>
<xsl:template name=“svg_one”>
  </xsl:param name=“offset”/>
  <svg:g stroke=“black” stroke-width=“1” stroke-opacity=“0”>
    <xsl:attribute name=“transform”>translate(<xsl:value-of
select=“$offset”/>,10)</xsl:attribute>
    <!-- Import svg data here for numeral ‘1’ -->
  </svg:g>
</xsl:template>
<!-- (Remaining digit templates cut for brevity) -->
</xsl:stylesheet>
```

If the ‘guess’ parameter is non-null and the ‘answer’ parameter is non-null, they are compared. If equal, the text “Correct” is included in the XHTML response. If unequal, the text “Incorrect” is returned in the XHTML response.

The Javascript script transform.js (see Table 6 below) is returned embedded with the XHTML response. The script adds and randomizes a z-coordinate to each endpoint of the lines comprising the representation of each digit, and then randomly rotates it before displaying the initial orthogonal projection, all on the client side during initialization for convenience. (The z-coordinates are stored in the SVG DOM, though these attributes are not part of the SVG specification.) After initialization, it handles mouse-press and mouse-move events such that the user on the client side may smoothly and continuously interact with the representation, by rotating the orthogonal projection of the three-dimensional model through all possible angles in order to find the correct orthogonal projection, and thus the correct response to the challenge.

```
TABLE 6
// Force ‘onload’ event
document.getElementById(“svg1”).addEventListener(“load”,initDoc,-
false);
var svgdoc = null;
// Initialize svg document variable and initialize point arrays
function initDoc(evt)
{
  if( svgdoc == null )
  {
    svgdoc = evt.target.ownerDocument;
    initLines( );
  }
}
// Declare global point arrays
var lines = new Array( );
var lineX1 = new Array( );
var lineY1 = new Array( );
var lineZ1 = new Array( );
var lineX2 = new Array( );
var lineY2 = new Array( );
var lineZ2 = new Array( );
// Initialize svg lines
function initLines( )
{
  // Assume all lines are to be transformed
  var allLines = svgdoc.getElementsByTagName(“line”);
  for(e=0;e<allLines.length;e++)
  {
    var numLines = lines.length;
    // Initialize global point arrays, setting the
    // z-coordinate to a random value
    lines[numLines] = allLines[e];
    lineX1[numLines] = lines[numLines].getAttribute(“x1”);
    lineY1[numLines] = lines[numLines].getAttribute(“y1”);
    lineZ1[numLines] = Math.round( Math.random( ) * 20 − 10 );
    lineX2[numLines] = lines[numLines].getAttribute(“x2”);
    lineY2[numLines] = lines[numLines].getAttribute(“y2”);
    lineZ2[numLines] = Math.round( Math.random( ) * 20 − 10 );
  }
  // Randomize the viewing angle of the 3D model
  var alpha = Math.random( ) * Math.PI;
  var beta = Math.random( ) * Math.PI;
  rotate( alpha, beta, 0 );
  // Make all svg elements visible
  var allGroups = svgdoc.getElementsByTagName(“g”);
  for(g=0;g<allGroups.length;g++)
  {
    allGroups[g].setAttribute(“stroke-opacity”, “1” );
  }
}
// Declare transformation matrices
var scale = new Array( new Array(1, 0, 0, 0),
```

```
  new Array(0, 1, 0, 0),
  new Array(0, 0, 1, 0),
  new Array(0, 0, 0, 1) );
```

var rotZ = new Array( new Array(0, 0, 0, 0),

new Array(0, 0, 0, 0),
new Array(0, 0, 1, 0),
new Array(0, 0, 0, 1) );

var rotY = new Array( new Array(0, 0, 0, 0),

new Array(0, 1, 0, 0),
new Array(0, 0, 0, 0),
new Array(0, 0, 0, 1) );

var rotX = new Array( new Array(1, 0, 0, 0),

new Array(0, 0, 0, 0),
new Array(0, 0, 0, 0),
new Array(0, 0, 0, 1) );

var trans = new Array( new Array(1, 0, 0, −8),

```
  new Array(0, 1, 0, −12),
  new Array(0, 0, 1, 0),
  new Array(0, 0, 0, 1) );
```

```
var world = new Array( new Array(4), new Array(4), new Array(4),
new Array(4) );
// Standard matrix multiplication
function multiply4×4( mA, mB )
{
  var mC = new Array( new Array(4), new Array(4), new Array(4),
  new Array(4) );
  // Loop through each element of C
  for (i = 0; i < 4; i++)
  {
    for (j = 0; j < 4; j++)
    {
      mC[i][j] = 0.0;
      // Calculate the dot product of ith row of A and jth column of B
      for (k = 0; k < 4; k++)
        mC[i][j] += mA[i][k] * mB[k][j];
    }
  }
  return mC;
}
// Standard matrix multiplication
function multiply1×4( mA, mB )
{
  var mC = new Array(4);
  // Loop through each row of C
  for (i = 0; i < 4; i++)
  {
    mC[i] = 0.0;
    for (j = 0; j < 4; j++)
    {
  mC[i] += mA[j] * mB[i][j];
    }
  }
  return mC;
}
// Reinitialize the rotation matrices every time the angle changes
function initRotZ( gamma )
{
  rotZ[0][0] = Math.cos( gamma ); rotZ[0][1] = −Math.sin( gamma );
  rotZ[1][0] = Math.sin( gamma ); rotZ[1][1] = Math.cos( gamma );
}
function initRotY( beta )
{
  rotY[0][0] = Math.cos( beta ); rotY[0][2] = −Math.sin( beta );
  rotY[2][0] = −Math.sin( beta ); rotY[2][2] = Math.cos( beta );
}
function initRotX( alpha )
{
  rotX[1][1] = Math.cos( alpha ); rotX[1][2] = −Math.sin( alpha );
  rotX[2][1] = −Math.sin( alpha ); rotX[2][2] = Math.cos( alpha );
}
// Reinitialize the world matrix every time the viewing angle changes
function initWorld( alpha, beta, gamma )
{
  initRotZ( gamma );
  var srz = multiply4×4( rotz, scale );
  initRotY( beta );
  var srzy = multiply4×4( rotY, srz );
  initRotX( alpha );
  var srzyx = multiply4×4( rotX, srzy );
  var srzyxt = multiply4×4( srzyx, trans );
  return srzyxt;
}
// Rotate the world to a new viewing angle
function rotate( alpha, beta, gamma )
{
  var xyzw;
  var xyzw_prime;
  // Reinitialize world matrix
  var world = initWorld( alpha, beta, gamma );
  // Compute new values for orthogonal projections of
  // rotated x, y and z values
  for(l=0;l<lines.length;l++)
  {
    xyzw = new Array( lineX1[l], lineY1[l], lineZ1[l], 1 );
    xyzw_prime = multiply1×4( xyzw, world );
    lines[l].setAttribute( “x1”, xyzw_prime[0] );
    lines[l].setAttribute( “y1”, xyzw_prime[1] );
    xyzw = new Array( lineX2[l], lineY2[l], lineZ2[l], 1 );
    xyzw_prime = multiply1×4( xyzw, world );
    lines[l].setAttribute( “x2”, xyzw_prime[0] );
    lines[l].setAttribute( “y2”, xyzw_prime[1] );
  }
}
// Declare global variable to keep track of dragging state
var dragging = “false”;
// Handle user events
function beginDrag( evt )
{
  if( evt )
  {
    if( dragging == “false” )
    {
      dragging = “true”;
    }
  }
}
function endDrag( evt )
{
  if( evt )
  {
    if( dragging == “true” )
    {
      dragging = “false”;
    }
  }
}
function continueDrag( evt )
{
  if( evt )
  {
    if( dragging == “true” )
    {
      var alpha = ( evt.clientY / 100 ) * 180;
      alpha = alpha * ( Math.PI / 180 );
      var beta = ( evt.clientX / 100 ) * Math.PI;
      rotate( alpha, beta, 0 );
    }
  }
}
```

Upon finding the correct projection angle, the user may enter the recognized digits into a field and post the answer to the server for verification. The answer is sent to the same script that generated the current page.

What is claimed is:

1. A method for using software to generate representations of visual tests that affect the increase of time required for computer-automated systems to respond to the tests with correct answers, distinctively and in such a way that said tests can be used to more effectively discriminate between computer-automated systems, which might themselves be generating requests for server-side resources of a client-server application, and human beings who, while they may be computer-aided, are less likely to be using computers to automate the submission of said requests. Said method is a useful and significant improvement on existing and ordinary tests that are used to provide some reliability in making such distinctions because said method: a) involves dynamic systems of data to augment the use of static images, b) employs continuous interaction, and c) is programmatically extensible.

2. The method of claim 1, wherein the software has been manually or programmatically extended in a mundane way by: (a) configuration of data, (b) adjustment of operational parameters, (c) the addition of data, or (d) further distortion.

3. The method of claim 1, wherein the software has been extended in a non-mundane way by enhancement or improvement of the algorithms inherently present in the software's process for: (a) distortion of data, (b) transformation of data, or (c) handling of client interaction with representations of the dynamic system of rendering data, as long as the software still primarily relies on said method.

4. The method as provided for in claim 2, wherein the software has been further extended in a non-mundane way by enhancement or improvement of the algorithms inherently present in the software's process for: (a) distortion of data, (b) transformation of data, or (c) handling of client interaction with representations of the dynamic system of rendering data, as long as the software still primarily relies on said method.
